(19) United States
(12) Patent Application Publication
(10) Pub. No.: US 2026/0051187 A1
(43) Pub. Date: Feb. 19, 2026

(54) VISUAL CODE AUTHENTICATION VIA HUMAN MOTION AND SENSOR MEASUREMENTS

(71) Applicant: George Mason University, Fairfax, VA (US)

(72) Inventors: Qiang Zeng, Herndon, VA (US); Chuxiong Wu, Fairfax, VA (US)

(73) Assignee: George Mason University, Fairfax, VA (US)

(21) Appl. No.: 19/282,208

(22) Filed: Jul. 28, 2025

Related U.S. Application Data
(60) Provisional application No. 63/683,135, filed on Aug. 14, 2024.

(51) Int. Cl. G06V 20/00; G06V 30/146; G06V 30/224

(52) U.S. Cl. CPC G06V 20/95; G06V 30/1463; G06V 30/224

(57) ABSTRACT

Systems, apparatuses, and methods may provide for technology that identifies user data decoded from a visual code and an orientation of a mobile device that displayed the visual code. The technology identifies based on the user data, a sensor measurement generated by a sensor of the mobile device, and determines whether to perform a computing process based on the sensor measurement and the orientation.

### PRIORITY

This application is a non-provisional application that claims priority to U.S. Provisional Patent Application No. 63/683,135, filed Aug. 14, 2024, which is incorporated herein by reference.

### GOVERNMENT LICENSE RIGHTS

This invention was made with Government support under grant number 2309550 and 2309477 awarded by the National Science Foundation. The government has certain rights in the invention.

### TECHNICAL FIELD

Examples generally relate to authentication. Examples include identifying orientation of a computing device that displays a visual code and verifying the orientation for authentication.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a unsecure computer authentication process and enhanced authentication process according to an embodiment;

FIG. 2 is a process flow of an example of the enhanced authentication process of FIG. 1 according to an embodiment;

FIGS. 3A-3B illustrate a process to determine the poses of a smartphone or other mobile device according to an embodiment;

FIG. 4 is a motion-based multi-factor authentication process according to an embodiment;

FIG. 5 is a motion-based multi-factor authentication system according to an embodiment; and

FIG. 6 is a flowchart of an examples of a method of authenticating a user based on visual codes and orientation of a mobile device according to an embodiment.

### DESCRIPTION OF EMBODIMENTS

Visual code (e.g., a quick-response (QR) is a type of two-dimensional barcode that can store a large amount of information, such as URL, contact information, account data, or other data, encoded as a pattern of black and white squares; PIN+ that is Computer Vision Authentication referring to a system that uses both a Personal Identification Number (PIN) and computer vision technology for user authentication; aruco marker that is a 2D binary-encoded fiducial patterns designed to be quickly located by computer vision systems, etc.) may be used for authentication and has gained enormous popularity in the realm of computing systems. Visual codes present code in a machine-readable format that is undecipherable by a human. Visual code authentication provides an efficient and touch-free experience, obviating the necessity for physically conveying identification, cash, credit cards, and/or other manual operations such as receipt signing, presenting government identifications, etc.

Such visual code authentication is convenient but as the usage of visual codes has increased, malicious actors have devised ways to fraudulently obtain and use such visual codes circumventing security protocols. Accordingly, concerns regarding the security of visual code has increased alongside the increased adoption.

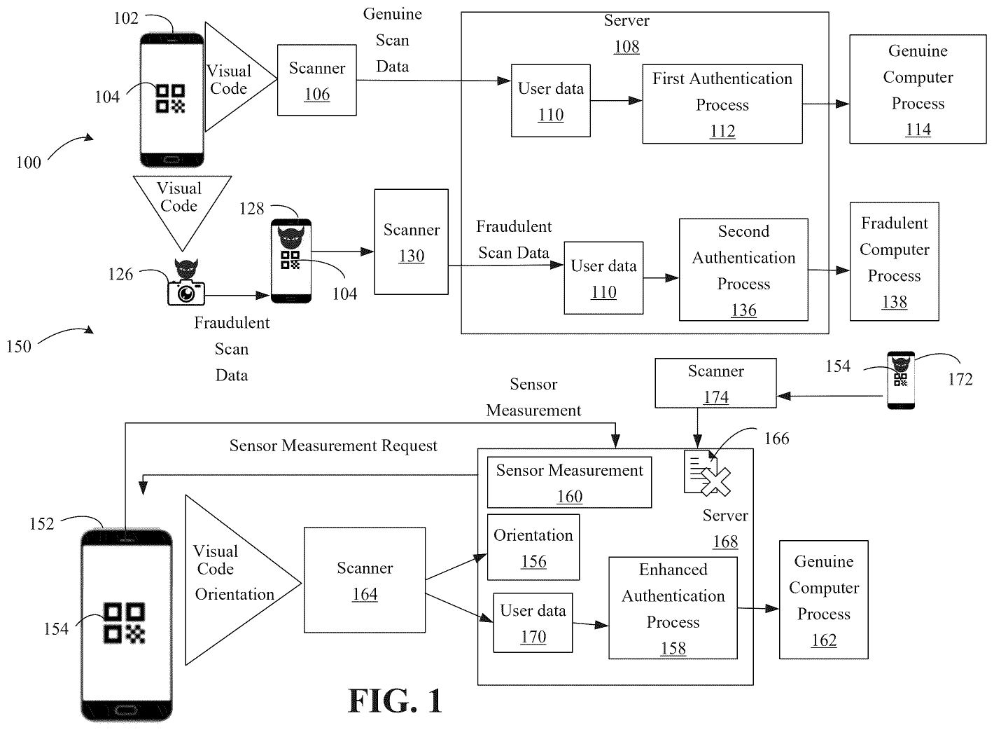

One such unsecure computer authentication process 100 is shown in FIG. 1. In unsecure computer authentication process 100, a visual code 104 (e.g., QR code, PIN+, aruco marker, etc.) is displayed on a mobile device 102. A visual code as described herein may be any machine-readable format that encodes data readable by computer vision techniques. The user of the mobile device 102 may be attempting to perform a computing process that relies on authentication. That is, if the computing process is performed if the user can be verified and authenticated based on the visual code 104. Otherwise, if the authentication is unsuccessful (e.g., the user cannot be authenticated), the computing process is blocked from being performed. Some examples of the computing process include payment to a merchant, unlocking an automated door that permits entry into a secure area, unlocking a secure compartment of a delivery robot, gaining electronic access through an automated checkpoint (e.g., electronic turnstiles) and paying for a public transportation such as a train, accessing an entertainment source (e.g., electronic tickets for a sporting event, etc.).

As shown in unsecure computer authentication process 100, a user only shows the visual code 104 to perform authentication. The visual code 104 can be generated by a mobile payment application for example, or another application that is associated with the authentication. A scanner 106 (may be a fixed scanner such as the scanner on a point-of-sale system, or moveable scanner such as a handheld scanner) may scan the visual code 104 to perform the authentication. The visual code 104 encodes information, such as a user account identification, name of the user, date-of-birth of the user, cards (e.g., credit card, debit card, transit payment card, license, government identification, etc.) associated with the user, and/or a timestamp.

The scanner 106 may image the visual code 104 and decode the visual code 104 to generate user data 110 (e.g., decoded information). The user data 110 may be part of the genuine scan data that is sent from the scanner 106 to server 108. For example, the scanner 106 sends decoded bits with other transaction data in-formation (e.g., such as the transaction amount and currency type), to the server 108 (e.g., a back-end of a payment system for verification, authentication system to gain access to a secure area through a fully automated doorway, etc.). The server 108 may perform a first authentication process 112 based on the user data 110. The first authentication process 112 may verify that the user data 110 is valid and corresponds to the user. If the data contained in the user data 110 is deemed valid (matches existing records such as the user account ID decoded from visual code 104 matching a verified and recorded user account ID stored on server 108), an automated computer process is authorized, which in this example is the genuine computer process 114. Otherwise, if hypothetically the user data 110 cannot be verified (user account ID does not match any existing recorded user verified and recorded user account ID stored on server 108), the genuine computer process 114 would be blocked from being executed.

In unsecure computer authentication process 100, a malicious actor attacker scans (images) the visual code 104 with camera 126 to acquire the visual code 104 displayed on the mobile device 102. A mobile device 128 of the malicious actor can display the visual code 104 on the mobile device 128 to impersonate the user and perform fraud. The malicious actor may not decipher the encrypted data contained in the visual code 104 (e.g., the user account identification, username, payment details, etc.) in the visual code 104. Rather, the malicious actor simply re-displays the user's visual code 104 on the mobile device 128. The mobile device 128 of the malicious actor may be different from the mobile device 102 of the user. A scanner 130 may scan the visual code 104 displayed on mobile device 128. Since the visual code 104 displayed on mobile device 128 is an exact copy of the visual code 104 generated and displayed by the mobile device 102, the visual code 104 on the mobile device 128 is considered valid.

Accordingly, the server 108 may re-generate the user data 110 based on fraudulent scan data (the visual code 104 displayed on the mobile device 128) received from the scanner 130 and based on the fraudulent display of the visual code 104 on the mobile device 128. A second authentication process 136 is then performed based on the user data 110, which is found to be successful (e.g., the user data 110 is found to be genuine and authorized for a computer process such as gaining access to a secure area or automated payment). A fraudulent computer process 138 is then performed on the usage of the visual code 104 by the malicious actor. Such an attack may be referred to as a reply attack (e.g., malicious actor captures a valid data transmission (like a login token or payment request) and resends (replays) it to trick a system into performing an action again.).

Such replay attacks are costly in terms of security and financial losses. For example, replay attacks can cause double payments in e-commerce or banking systems, unauthorized purchases or money transfers if the visual code is not time-bound, bypassing authentication (e.g., reusing a session token or login QR code), etc. Some replay attacks result in gaining access to sensitive areas of a system, resulting in a breach of data protection laws like GDPR or HIPAA. Further, a lack of message integrity or non-repudiation could result in legal challenges and trust in systems decline if users are charged twice or experience unauthorized access. Furthermore, malicious actors may impersonate users and/or gain access to secure areas.

Similar to the notorious relay attacks targeting chip card payment systems, replay attacks pose a significant threat to visual code authentication systems. Replay attacks against visual code authentication is not only feasible, but also cheap. Attackers can use affordable commercial off-the-shelf smartphones or cameras to record visual codes. Additionally, replay attacks are often stealthy, as a visual code can be sent to a remote attacker to conduct a fraudulent authentication.

Turning to enhanced authentication process 150, to bolster the security of visual code authentication, examples herein include an innovative implicit second-factor authentication approach that exploits smartphone sensors. In the proposed approach, when a user presents a visual code 154 (e.g., a QR code such as a 2-dimensional matrix or a visual pattern), on a computing device 152 (e.g., a mobile device) to a scanner 164, the camera of the enhanced authentication process 150 captures not only the visual code itself but also captures an orientation of the computing device 152 (e.g., pose and/or orientation). By utilizing orientation as an additional factor, in conjunction with visual code 154 decoding, the scanner 164 verifies the authenticity of the computing device 152 presenting the visual code 154. Such a solution to the problem noted above (insecure electronic authentication) demonstrates the effectiveness of examples herein, affirming security, accuracy and robustness.

For example, the scanner 164 can include poses of the computing device 152 as the second authentication factor. The enhanced authentication process 150 provides an additional layer of security for visual code authentication based on the simple yet concrete fact: what the scanner 164 images (e.g., the observed poses and/or motion of the computing device 152) correlate with the actual poses of the computing device 152 (sensed by the built-in sensors of computing device 152).

In detail, the computing device 152 provides sensor measurements 160 of sensors of the computing device 152 to the server 168. The sensor measurements 160 serve as ground truth for authentication, in addition to the visual code 154. For example, poses sensed by the built-in sensors of the computing device 152 may serve as the ground truth and are provided as sensor measurements 160.

The scanner 164 may detect an orientation of the computing device 152 based on images of the computing device 152. For example, the scanner 164 may determine an orientation 156 that includes one or more of observed poses, three-dimensional motion that is estimated two-dimension images, position, global positioning system (GPS) coordinates or angular velocity of the computing device 152 based on images (e.g., video) of the computing device 152.

The scanner 164 further detects the visual code 154 and may decode the visual code 154 similar to as described above with respect to scanner 106. User data 170 (e.g., decoded information) is decoded form the visual code 154 (the user data 170 was originally encoded into the visual code 154). The visual code 154 may also encode a requested computer process that is requested to be processed if the authentication is successful. The scanner 164 provides the orientation 156 (which is an estimation of orientation) and the user data 170 to the server 168, along with an authentication request to perform authentication and a computer process if the authentication is successful.

When the server 168 receives the orientation 156, the user data 170 and the authentication request, the server 168 can push a sensor request to an application (e.g., a wallet and/or identification application) of the computing device 152 that generated the visual code 154. The authentication request can include a request for the sensor measurement when the visual code 154 was generated and/or presented to scanner 164. The application may record and store sensor measurement when the visual code 154 is displayed, and when the sensor request is received. Further, the application provides the stored sensor measurement to the server 168 in response to a request for the sensor measurement. Thus, the server 168 (e.g., a computing device), fetches sensor measurements 160 (e.g., sensor data such as positional measurements, sensed angular velocity and/or motion) from an application deployed on the computing device 152 (e.g., mobile device), and determines the sensor measurement 160 based on the sensor measurements 160.

Specifically, when the computing device 152 displays the visual code 154, an Inertial Measurement Unit (IMU) in the computing device 152 may collect information regarding the real orientation of the computing device 152, which is employed as the ground truth. Other sensors (accelerometer, gyroscope, magnetometer, sensor fusion techniques of multiple sensors, software based gravity sensors, linear acceleration sensors, rotation vector sensors) of the computing device 152 may also be used to detect position and/or acceleration of the computing device 152.

The server 168 checks whether the orientation 156 (the estimated orientation detected by scanner 164 such as position, sensed angular velocity and/or motion) of the computing device 152 displaying the visual code 154 matches the sensor measurements 160 (e.g., the ground truth). The server 168 compares the orientation 156 (estimation) of the computing device 152 to the actual orientation of the sensor measurements 160, to determine whether the requested computer process should be authorized. In some examples, the computing process is performed in response to the orientation 156 being within a distance (e.g., Euclidean distance, Manhattan distance, Minkowski distance, Chebyshev distance, etc.) of the sensor measurement 160.

The enhanced authentication process 158 thus verifies the user data 170 to ensure that the user has authorization to perform the requested computer process and verify if the orientation 156 matches the sensor measurements 160. In this example, the user does have authorization to perform the requested computer process, and the orientation 156 matches the sensor measurements 160. Accordingly, the enhanced authentication process 158 successfully validates and authenticates (genuine and non-fraudulent request) the user data 170 based on the comparison of the sensor measurements 160 and the orientation 156, and performs the genuine computer process 162 (e.g., unlocks a door to permit physical access to a secure location, performs a transaction, identify verification, etc.).

In this example and similar to unsecure computer authentication process 100, a malicious actor scans the visual code 154 while the visual code 154 is displayed on the computing device 152. The malicious actor may then attempt to use the visual code 154 by displaying the visual code 154 on a computing device 172. A scanner 174 scans the visual code 154 and estimates an orientation of the computing device 172 based on images of the computing device 172. User data 170 may also be decoded from the visual code 154. The estimated orientation estimated by the scanner 174 and user data 170 are provided to the server 168 along with a request to perform a computer process similar to genuine computer process 162 if the authentication is successful. In this example, the estimated orientation of the computing device 172 detected by the scanner 174 does not match the sensor measurements 160 (the ground truth) of the computing device 172, and therefore the computer process is blocked 166 from being executed for the malicious actor. Accordingly, the replay attack mentioned above can be prevented because the computing process is blocked from being performed if the sensor measurement 160 does not match the orientation 156.

The multi-factor authentication carries several properties. First, the enhanced authentication process 150 is secure against replay attacks. The malicious actor would need to mimic the orientation of the computing device 152 in real time in order to successfully authenticate and impersonate the user. However, studies have shown that people tend to overestimate acute angles and underestimate obtuse angles when reproducing angles, even if there are no real-time constraints. Thus, it is unlikely that the malicious actor can reproduce the orientation of the computing device 152 in real time, particularly as the orientation may only be noticeable for a short period of time.

Second, the multi-factor authentication of the enhanced authentication process 150 is a software-based solution, which does not rely on special hardware on the computing device 152. Third, the multi-factor authentication of the enhanced authentication process 150 provides an implicit authentication factor that does not rely on user modifications or adjustments, maintaining the excellent and wide-spread adoption of visual code authentication. That is, the user is not restricted to presenting the computing device 152 in any specific orientation (e.g., position). Fourth, the multi-factor authentication of the enhanced authentication process 150 may be generalized to other scenarios. Visual codes are utilized in various scenarios, including gate access control in buildings, ticketing services, and profile sharing in social media applications. Examples can easily be applied to such scenarios.

Furthermore, the enhanced authentication process 150 does not rely on permissions from the user, as the enhanced authentication process 150 merely uses zero-permission motion sensors to identify the sensor measurements 160. In addition, the data collection is only conducted while the visual code 154 is displayed, which alleviates privacy

Furthermore, the scanner 164 may be enhanced to translate two-dimensional (2D) images captured by a monocular camera of the scanner 164 to fine-grained three-dimensional (3D) pose information. Further, an effective method that determines the correlation between orientation is devised. Extensive experiments demonstrate a high level of accuracy, robustness, and resilience to attacks. Unlike existing approaches, examples herein are the first that enhance visual code security through correlation (e.g., without using fingerprints or biometrics).

The enhanced authentication process 150 may also prevent and/or reduce mimicry attacks which is a variant of replay attacks. The enhanced authentication process 150 may further reduce and/or prevent perspective distortion attacks. An attacker (malicious actor), that understands the multifactor authentication described herein and the difficulties of impersonating a user's orientation in real time, may choose to perform perspective distortion on the replayed QR code. Specifically, the attacker employs computer vision techniques to analyze the orientation of the computing device 152 and meanwhile distorts the replayed visual code 154, rendering a visual effect that appears to show the poses of a malicious actor mobile device displaying the visual code 154 (replayed) correlates with the poses of the victim's smartphone. However, the perspective distortion attacks rely on specialized algorithms and ample computing resources to lively infer poses of the victim's smartphone and distort the visual code 154, which make the distortion attack less practical in real world situations. More importantly, the perspective distortion attacks may be easily detected, as the boundaries of the distorted replayed visual code 154 are not parallel to those of the smartphone screen.

A variant of the attack is to record a video or generate a fake video, e.g., using artificial intelligence (AI), which includes a smartphone that shows the visual code 154 and the orientation of the computing device 152. Then, a large screen is used to show the video to a scanner. However, with this attack, the phone is not live but rendered using a screen. Either of the two distinct types of techniques can detect such attacks: (1) techniques that detect AI-created videos, and (2) techniques that detect whether the part showing phone boundaries belongs to a screen based on, e.g., moire patterns and flickering. Such techniques may be readily combined with examples herein to further augment security in computing environments.

Accordingly, examples herein identify user data 170 decoded from the visual code 154 and the orientation 156 of computing device 152 (e.g., mobile device) that displayed the visual code 154, identify, based on the user data 170, a sensor measurement generated by a sensor of the computing device 152, and determine whether to perform a genuine computer process 162 (e.g., computing process) based on the sensor measurement 160 and the orientation 156.

It is worthwhile to note that while certain functions are described with respect to specific actors, it will be understood that certain functions can be performed by the server 168 rather than scanner 164, and vice-versa. In some examples, the scanner 164 may be combined with the server 168 for example.

Accordingly, the enhanced authentication process 150 is enhanced relative to the unsecure computer authentication process 100. That is, computing processes such as unsecure computer authentication process 100 suffer from security vulnerabilities and are consequently prone to attacks. The enhanced authentication process 150 remedies such vulnerabilities to enhance security, resulting in a robust and low-latency authentication process with little to no overhead for users. The enhanced authentication process 150 may be a mobile payment system authentication process, an access control system authentication process and/or an identify control system authentication process.

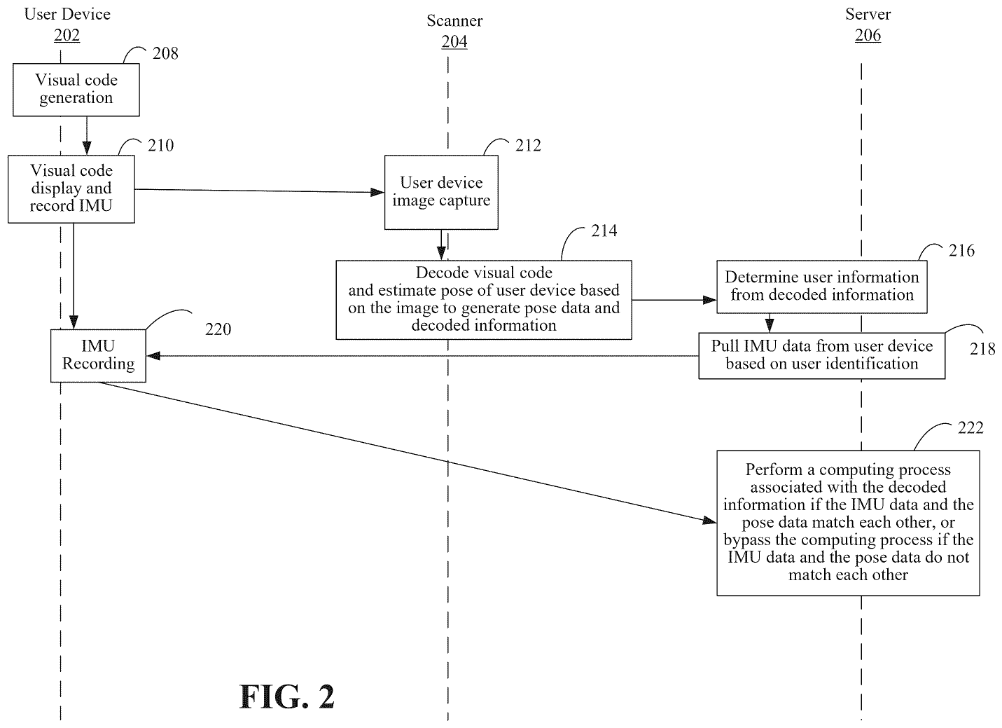

Turning now to FIG. 2, a process flow for multi-factor authentication as described herein is illustrated. Specifically in FIG. 2, the orientation includes a pose of user device 202 (e.g., a mobile device such as a smartphone). A user unlocks the user device 202 and launches an application (e.g., payment application) that relies on authentication of the user prior to performing a computing process. The user device 202 generates a visual code 208. For example, an application of the user device 202 generates the visual code 208. The user device 202 records IMU data as the IMU recording 220 and displays the visual code 210. The user displays the visual code to a scanner 204. The scanner 204 scans and performs user device image capture 212. Once the code is detected by the scanner 204, a beep alert is emitted to indicate a successful scan, and the user may then stow the user device 202.

The scanner decodes the visual code (e.g., payment code) and estimates a pose of the user device 202 based on the image to generate pose data and decoded information 214. The scanner 204 sends the decoded information and estimated pose to a server 206 (e.g., a back-end server). The server 206 determines user information (e.g., account information) from the decoded information 216. The server 206 may then identify an application and/or user device 202 associated with the user to request sensor data from the user device 202. Thus, the server 206 pulls and/or fetches the IMU data (IMU recording) from the application that generated the visual code 222. That is, the server 206 pulls the IMU data from the user device based on the user identification 218. The application is associated with the user information (e.g., user information was used to login to the user device 202).

The server 206 makes a decision whether to authenticate the user or not by comparing the IMU data with the pose estimated by the scanner 204, and sends the result to the scanner 204 and the user device 202. If the estimated pose matches with the pose indicated by the IMU data, the computing process (e.g., payment) is authorized; otherwise, the computing process is rejected, and the user is notified to re-generate a visual code and repeat the authentication procedure until a maximum number of attempts is reached. Accordingly, server 206 performs a computing process associated with the decoded information if the IMU data and the pose data match each other, or bypasses the computing process if the IMU data and the pose data do not match each other 220.

It is worth clarifying that a visual code encodes an account identification (ID) of the user. Thus, the server 206 only compares the scanner-observed pose data with IMU data fetched from the associated application logged in with the account ID. In other words, the decision-making process involves a one-to-one verification problem rather than a one-to-many identification problem, meaning that the accuracy does not decline as the number of users increases.

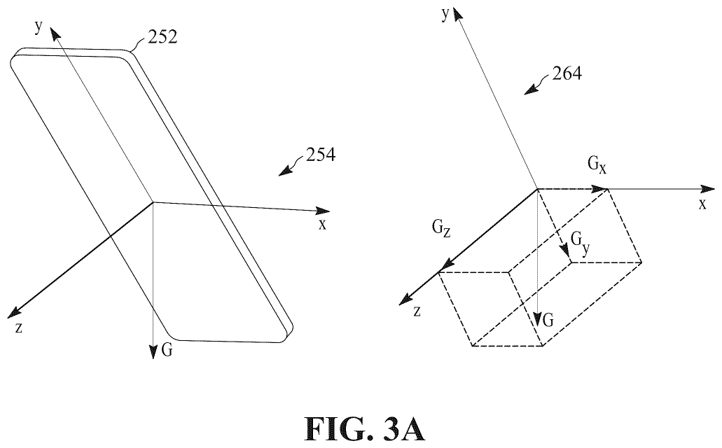

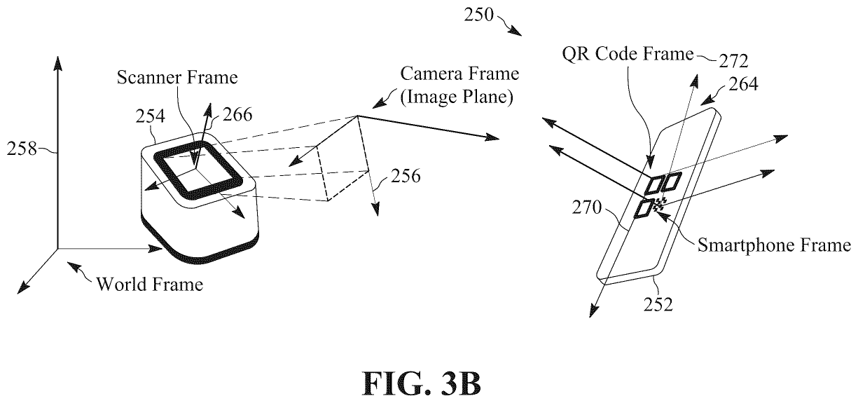

FIGS. 3A-3B illustrate a process to determine the poses of a smartphone 252.

### Smartphone Pose Estimation

To determine the poses of the smartphone 252 from recorded video of a scanner 254, examples perform visual code detection to locate the visual code (QR code 270) in the video frames of the video. For example, suppose that the visual code is a QR code 270. In the QR code 270, three square position markers are situated at top-left, top-right, and bottom-left corners. These markers facilitate the process of locating and orienting the QR code 270, enabling a QR code reader, such as scanner 254, to identify the QR code 270 accurately.

After locating the QR code 270, examples estimate the pose of the smartphone 252 (a user device) in a world coordinate system 258 represented as the world frame. When a QR code is detected by the scanner 254, the rotation of the smartphone 252 may be obtained by the following equation 1:

$${R}_{World}^{Phone} = {R}_{World}^{Cam} \cdot {R}_{Cam}^{QR} \cdot {R}_{QR}^{Phone} \qquad Equation 1$$

In Equation 1, matrix

$${R}_{World}^{Phone}$$

represents the rotation matrix from the world coordinate system of the world coordinate system 258 to a smartphone coordinate system 264 (XYZ axis shown over the smartphone 252). The matrix

$${R}_{World}^{Cam}$$

denotes the rotation from the world coordinate system 258 to a camera frame 256 (e.g., a scanner camera coordinate system) which can be calculated by Equation 2:

$${R}_{World}^{Cam} = {R}_{World}^{Scanner} \cdot {R}_{Scanner}^{Cam} \qquad Equation 2$$

In Equation 2,

$${R}_{World}^{Scanner}$$

is the rotation matrix from the world coordinate system 258 to the scanner frame 266, and

$${R}_{Scanner}^{Cam}$$

is the rotation matrix from the scanner frame 266 to the camera frame 256. For scanners with integrated IMU sensors, the scanner frame 266 is defined as the IMU sensor coordinate system.

$${R}_{World}^{Scanner}$$

may be obtained from the IMU sensor built in the scanner 254. For instance, certain mobile devices (e.g., Android™) provides the getRotationMatrix( ) method, which uses the gravity sensor and the geomagnetic field sensor to get the rotation matrix for a device. Since the camera is fixed in the scanner 254, the pose of the camera is stable relative to the scanner 254, and the transformation matrix

$${R}_{Scanner}^{Cam}$$

to constant and can be predetermined based on the relative poses. For example, in the case where the scanner 254 is a smartphone scanner, the camera frame 256 may be obtained by rotating the scanner 254 smartphone's IMU coordinate system by 180 degrees along its x-axis. In summary,

$${R}_{World}^{Cam}$$

can be calculated based on IMU data of the scanner 254. For scanners without IMU integrated, such as a hands-free scanners, examples may perform scanner orientation calibration.

The rotation matrix

$${R}_{Cam}^{QR}$$

represents the rotation of the QR code 270 with respect to the camera frame of the scanner camera coordinate system 256. Examples employ a Perspective-n-Point (PnP) based method, which minimizes the reprojection error from 3D-2D point correspondences, to estimate

$${R}_{Cam}^{QR} .$$

Specifically, a matrix

$${T}_{Cam}^{QR}$$

is defined to denote the homogeneous transformation from the scanner camera coordinate system 256 to a QR code frame 272 (QR frame or QR code coordinate system). As shown in Equation 3 below, the

$${T}_{Cam}^{QR}$$

includes

$${R}_{Cam}^{QR}$$

that is a 3×3 rotation matrix and a 3×1 position vector

$${T}_{Cam}^{QR} = [ \begin{matrix}{R}_{Cam}^{QR} & {P}_{Cam}^{QR} \\ {0}_{1 \times 3} & 1\end{matrix} ] \qquad Equation 3$$

With the transformation matrix

$${T}_{Cam}^{QR} ,$$

the coordinates of the four corners of the QR code 270 within the image plane of the scanner camera coordinate system 256 may be described by Equation 4, as outlined in accordance with the pinhole camera model:

$$[ \begin{matrix}{U}_{i} \\ {V}_{i} \\ 1\end{matrix} ] = [ \begin{matrix}{f}_{x} & 0 & {c}_{x} & 0 \\ 0 & {f}_{y} & {c}_{y} & 0 \\ 0 & 0 & 1 & 0\end{matrix} ] \cdot {T}_{Cam}^{QR} \cdot [ \begin{matrix}{X}_{i} \\ {Y}_{i} \\ {Z}_{i} \\ 1\end{matrix} ] \qquad Equation 4$$

In Equation 4, [Xi Yi Zi] represents the 3D position vector of the i-th corner of the QR code 270, and [Ui Vi] denotes the corresponding 2D position vector in the image frame captured by the camera. To simplify and without sacrificing generality, examples designate the QR code 270 frame's origin as the origin of the world coordinate system 258.

Given that the four corners of QR code 270 lie in the same plane, the z-axis coordinates Zᵢ within the QR code's 270 QR code frame 272 are uniformly set to zero. In Equation 4, fₓ and f_{y} are the focal lengths expressed in pixel units, while (cₓ, c_{y}) are the principal point which is at the image center of the QR code 270. fₓ, f_{y}, cₓ, and c_{y} are intrinsic parameters of a camera and can be obtained via one-time preliminary camera calibration.

By localizing the four corners within the image plane and providing corresponding 3D coordinates of the four corners, the transformation matrix may be deduced utilizing Equation 4. The rotation matrix

$${T}_{Cam}^{QR}$$

may be deduced utilizing Equation 4. The rotation matrix

$${R}_{Cam}^{QR}$$

is then used to estimate the orientation of the smartphone 252 in the world coordinate system 258, as illustrated in Equation 1.

The matrix

$${R}_{QR}^{Phone}$$

is defined as rotation from the QR code coordinate system 272 to the smartphone coordinate system 264. Examples use the sensor frame of the smartphone 252 to represent the smartphone coordinate system 264 since the sensor data is leveraged for authentication. As illustrated, the QR code coordinate system 272 is a right-handed coordinate system with the corner of the middle position marker as the origin, while the x-axis and y-axis are represented by two margins. That is, among the three square position markers of the QR code 270, the outermost vertex of the middle position marker is chosen as the origin of the coordinate system. For example, if the position markers are located at the top-right, top-left, and bottom-left corners of the QR code 270, the top-left corner of the position marker at the top-left corner of the QR code 270 is designated as the origin. The X-axis and Y-axis are defined by the edges of the QR code 270 that extend from this origin toward the other two position markers. Specifically, the vector from the origin to one adjacent position marker defines the X-axis, while the vector to the other defines the Y-axis. The Z-axis is then established using the right-hand rule, pointing perpendicular to the QR code 270 plane.

The sensor coordinate system is defined relative to the screen of the smartphone 252, and the x-axis of the smartphone 252 points to the right, the y-axis of the smartphone 252 points up, and the z-axis smartphone 252 points toward the outside of the screen of the smartphone 252. Since the coordinate systems of the QR code 270 and the smartphone 252 are predefined, the matrix

$${R}_{QR}^{Phone}$$

is predetermined.

Examples rely on Equation 5 to describe the relationship between the gravity measured in the world coordinate system 258 and in the sensor frame of the smartphone 252:

$$[ \begin{matrix}0 \\ 0 \\ g\end{matrix} ] = {R}_{World}^{Phone} \cdot gravity = {R}_{World}^{Phone} \cdot [ \begin{matrix}{G}_{x} \\ {G}_{y} \\ {G}_{z}\end{matrix} ] \qquad Equation 5$$

In Equation 5, g is the constant value of gravity, and [Gₓ G_{y} G_{z}] represents the gravity values measured by the smartphone 252 along the three axes of the smartphone 252.

To compare the rotation information estimated by a scanner with the sensor data recorded by a smartphone 252, examples calculate the gravity values estimated by the scanner 254 with the formula adapted from Equation 5 as shown in Equation 6 below:

$$[ \begin{matrix}{G}_{x} \\ {G}_{y} \\ {G}_{z}\end{matrix} ] \vert = {R}_{World}^{{Phone}^{- 1}} \cdot [ \begin{matrix}0 \\ 0 \\ g\end{matrix} ] = {R}_{World}^{PhoneT} \cdot [ \begin{matrix}0 \\ 0 \\ g\end{matrix} ] \qquad Equation 6$$

Examples perform smartphone pose estimation for each frame captured by the scanner, resulting in a sequence of data points representing the poses of the smartphone 252 during the presentation of the QR code 270. Each data point in the sequence corresponds to the gravity values along the three axes of the sensor coordinate system ([Gₓ G_{y} G_{z}]) of the smartphone 252. This sequence is then sent to a server (e.g., a backend server) for correlation determination.

### Data Pre-Processing

In some examples, the obtaining the pose data of the smartphone 252 inferred by the scanner 254 and a user identification in the QR code 270, the server acquires the IMU data from the smartphone 252 for comparison. The pose data determined by the scanner 254 and collected by the IMU of the smartphone 252 may both fluctuate and contain noises. Therefore, examples perform pre-processing operations on this data.

Examples may incorporate linear interpolation to fill gaps in the data that arise due to uneven sampling. IMU data may contain high frequency noises caused by environmental vibrations, such as sounds, examples apply a low-pass filter to filter out noises with high frequencies. As the vibration caused by human mobility is mostly less than 10 Hz, examples can select a low-pass Butterworth filter with a cut-off frequency of 10 Hz. Examples apply a median filter to remove outliers and smooth the data.

In this manner, two sequences of gravity data are obtained, denoted as:

$${G}_{S} = \{ {G}_{S}^{( 1 )} , {G}_{S}^{( 2 )} , … {G}_{S}^{( n )}$$

estimated by the scanner, and

$${G}_{P} = \{ {G}_{P}^{( 1 )} , {G}_{SP}^{( 2 )} , … {G}_{P}^{( n )}$$

collected by the IMU of the smartphone 252. Note that each data point in the gravity sequence contains three elements, each measures the force of gravity that is applied to the smartphone 252 on one of the sensor coordinate system's axes. The gravity data, as inferred by a camera and collected by the IMU of the smartphone 252 after preprocessing.

### Correlation Determination

After pre-processing, examples obtain sequences of gravity data, G_{S} and G_{P}. Note that each data point in the gravity sequences contains three elements, each representing the gravity projections along the respective sensor axis. To determine the correlation between the data sequences obtained from the camera and smartphone 252, examples calculate the Euclidean distances for each attribute in the sequences separately. To account for variations in the length of data n each time a user presents a QR code, examples obtain the average distances by dividing the Euclidean distances of each attribute by n. The resulting averaged Euclidean distances are used as features for training a classification model. The classification model is an AI-based classification model. The classification model is used to determine whether the data points are correlated. A positive classification result indicates successful authentication.

The IMU has demonstrated reliability as an instrument for evaluating various ranges of motion. Even low-cost IMUs may offer remarkable precision, with a maximum error of approximately 0.5 degrees. Particularly for short time intervals, the influence of IMU drift resulting from integration errors, sensor bias, and sensor noise may be minimal. The accuracy of smartphone sensors can vary across different devices.

To further strengthen the resilience examples herein may account for potential inaccuracies in IMU measurements, examples include utilizing correlation to assess the similarity of the shape between data sequences. Such an approach is based on the observation that despite the inherent inaccuracies and drift in IMU sensor data, the overall trend, whether increasing or decreasing, tends to be reliable. Specifically, examples employ the Pearson correlation coefficient (PCC), which is a widely used algorithm for quantifying the correlation between two time series. The PCC is calculated as the covariance of two data sequences divided by the product of their standard deviations. The resulting PCC value ranges from −1 to 1. A PCC value of 1 indicates a perfect positive linear relationship between the sequences, while a value of −1 suggests a perfect negative linear relationship. A PCC value of 0 indicates the absence of a linear relationship between the sequences.

In addition to utilizing the Euclidean distances and PCC scores, examples also leverage the following features regarding the differences between data sequences: minimum, maximum, difference between minimum and maximum, average, standard deviation, median absolute deviation, and median. Examples further calculate the fisher score to select fundamental features. The normalized fisher scores are shown in Table I hereinbelow:

TABLE I

| | Pose | | |
|---|---|---|---|
| Feature | X-axis | Y-axis | Z-axis |
| Euclidean | 1.00 | 0.24 | 0.39 |
| PCC | 0.36 | 0.26 | 0.21 |
| Minimum | 0.20 | 0.10 | 0.12 |
| Maximum | 0.92 | 0.23 | 0.44 |
| Max − Min Diff | 0.41 | 0.19 | 0.35 |
| Average | 0.99 | 0.27 | 0.38 |
| Std | 0.39 | 0.15 | 0.27 |
| MAD | 0.24 | 0.08 | 0.24 |
| Median | 0.79 | 0.26 | 0.79 |

Features with a normalized fisher score above 0.1 are selected.

### Scanner Orientation Calibration

Examples can also implement scanner orientation calibration. The smartphone 252 orientation estimation from recorded video may include knowledge of the orientation of the scanner 254.

Scanner 254 is equipped with IMUs, such as smartphone 252, may obtain

$${R}_{World}^{Scanner}$$

from the sensor data, as described above. For scanners without sensors such as IMUs, examples may perform scanner orientation calibration with a mobile device, which is a one-time effort. Specifically, a user displays a smartphone (not illustrated) displaying a QR code to the scanner 254 to be calibrated; meanwhile, the scanner 254 estimates the rotation of the smartphone and the smartphone records the rotation of the smartphone with built-in sensors. Note that during the calibration examples perform extrinsic parameters corresponding to the orientation of the scanner 254. The intrinsic parameters, which are solely determined by the camera of the scanner 254 and remain constant after the factory calibration, are not affected. It is also worth noting that recalibration is unnecessary as long as the pose of the scanner remains constant, meaning that

$${R}_{World}^{Scanner}$$

remains unchanged, even if the scanner is relocated. For example, on a flat checkout counter, the smartphone 252 can be moved without necessitating recalibration. Based on Equation 1, Equation 2, and Equation 5, we can derive the following:

$$Equation 7$$

$$[ \begin{matrix}0 \\ 0 \\ g\end{matrix} ] = {R}_{World}^{Scanner} \cdot {R}_{Scanner}^{Cam} \cdot {R}_{Cam}^{QR} \cdot {R}_{QR}^{Phone} \cdot [ \begin{matrix}{G}_{x} \\ {G}_{y} \\ {G}_{z}\end{matrix} ] = {R}_{World}^{Scanner} \cdot {QR}_{World}^{Scanner}$$

represents the rotation matrix from the world coordinate system 258 to the smartphone coordinate system 264 (e.g., frame of the smartphone 252) and Q is the multiplication of multiple matrices and vectors that are known. As a rotation matrix has only three rotational degrees of freedom,

$${R}_{World}^{Scanner}$$

may be determined with a one-time calibration procedure, even though multiple operations can enhance accuracy.

To evaluate the effectiveness of the scanner 254 orientation calibration, examples use a smartphone placed on a holder to serve as a scanner, mimicking the calibration process for hands-free QR code scanners widely adopted by retailers and users. During this process, examples consider the IMU sensor data of the scanner 254 as ground truth and compare the calibration results with the IMU sensor data. Results indicate that, with the one-time calibration, the average angular error along three axes is 0.04 radian (2.3 degrees), demonstrating the effectiveness of the proposed calibration method. Additionally, examples evaluate the authentication accuracy of examples herein based on the calibration results.

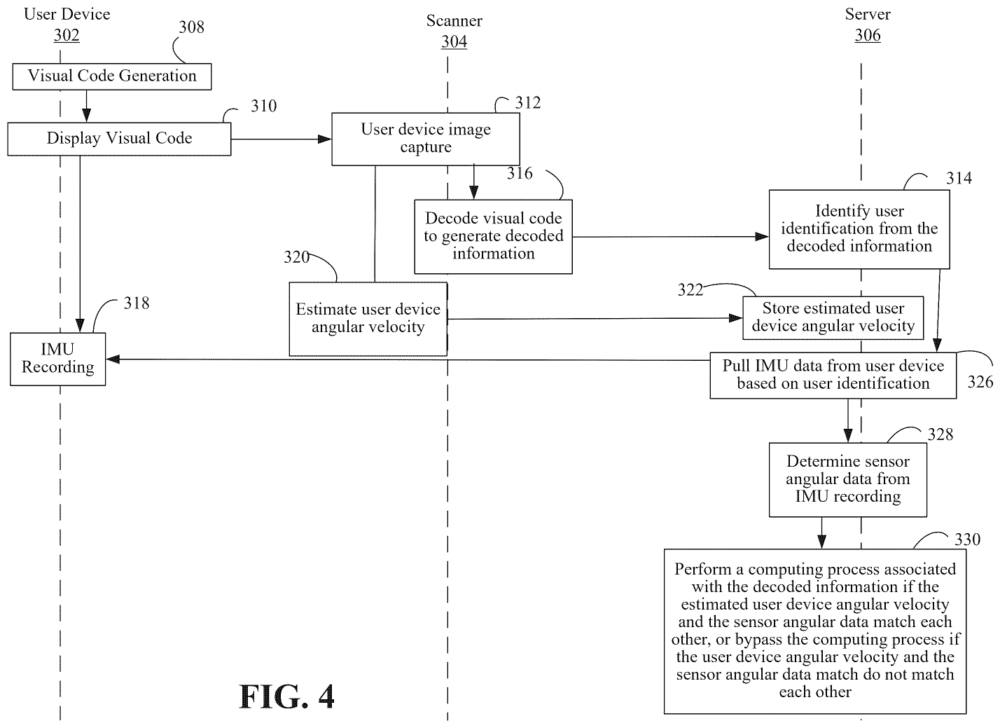

FIG. 4 illustrates a motion-based multi-factor authentication process. At the user device 302, a visual code is generated 308. The user may open an authentication application (e.g., a payment application such as a wallet) that generates a visual code for the computing process. The user device 302 then begins recording IMU data 318. The user presents the code to a scanner 304 to display the visual code 310. When the scanner 304 detects the visual code by performing user device image capture 312, the scanner 304 emits a beep alert to indicate a successful scan, allowing the user to stow the user device 302. The scanner decodes the visual code to generate decoded information 316 and estimates the poses of a camera that scans the visual code (e.g., a camera of scanner 304) and the poses of the user device 302 to estimate user device angular velocity 320. The scanner 304 then sends the decoded information to a server 306. The server 306 identifies user identification from the decoded information 314. The scanner 304 sends the angular velocity to the server 306, and the server 306 stores the estimated user device angular velocity 322. The server 306 then pulls the IMU data from the user device 302 based on the user identification 326 and as described above. The server 306 determines sensor angular data from the IMU recording 328.

The server 306 compares the IMU data with the estimated user device angular motion data velocity estimated by the scanner 304. That is, the server 306 performs a computing process associated with the decoded information if the estimated user device angular velocity and the sensor angular data match each other (authentication was successful), or bypasses the computing process if the user device angular velocity and the sensor angular data match do not match each other (authentication was not successful) 330. The result of whether the authentication was successful or unsuccessful, as well whether the computing process will execute, is provided both the scanner 304 and the user device 302.

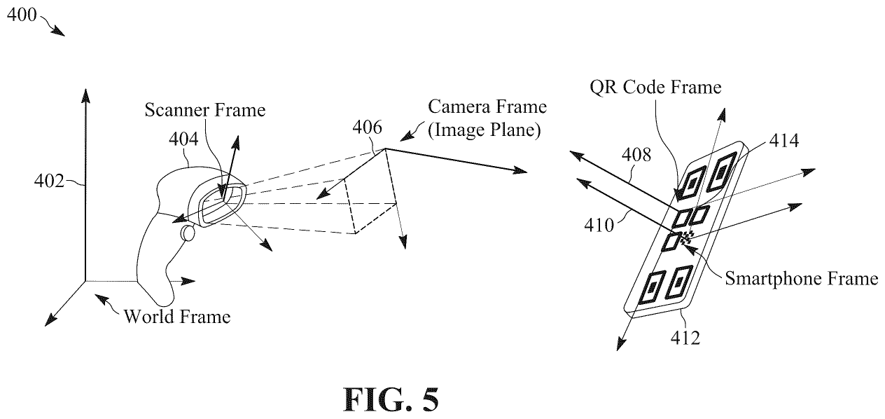

Turning now to FIG. 5, a motion-based multi-factor authentication system 400 is shown. The pose of a smartphone 412 in a world frame 402 may be calculated using the following equation 8:

$${R}_{World}^{Phone} = {R}_{World \vert}^{Cam} \cdot {R}_{Cam}^{QR} \cdot {R}_{QR}^{Phone} \qquad Equation 8$$

$${R}_{World}^{Phone}$$

denotes the rotation matrix that transforms from the world coordinate system of the world frame 402 to a smartphone coordinate system of a smartphone frame 410.

The matrix

$${R}_{QR}^{Phone}$$

represents the rotation from the QR code coordinate system (corresponding to QR code frame 408) of the QR code frame 408 to the smartphone coordinate system (corresponding to smartphone frame 410) of the smartphone 412. Examples can use the sensor frame of the smartphone 412 to define the smartphone coordinate system, as sensor data is used for authentication. As shown in FIG. 5, the QR code coordinate system is a right-handed system with the corner of the middle position marker as the origin, while the x-axis and y-axis align with two margins.

A sensor coordinate system is defined relative to the screen of the smartphone 412 in which the x-axis points to the right, the y-axis points up, and the z-axis extends outward from the screen. Since the coordinate systems of both a QR code 414 and smartphone 412 are predefined, the matrix

$${R}_{QR}^{Phone}$$

is also predetermined.

For hands-free scanners,

$${R}_{QR}^{Phone} ,$$

representing the orientation of the camera of the fixed scanner in the world frame, is fixed and may be predetermined by calibration. By contrast, hand-held scanners, such as handheld scanner 404, may change rotations in the world frame 402 at any time during the scanning procedure. Thus, the rotations vary with time and cannot be predetermined. To account for both handsfree scanners and hand-held scanners, examples use pose changes of the smartphone 412 as a second authentication factor. The insight is, despite the agnostic nature of the poses of the smartphone 412 in the word frame due to agnostic of the camera's orientation, the changes of the pose of the smartphone 412 may be determined, and the pose changes may also be captured by the IMU data of the smartphone 412 in terms of the gyroscope value of the smartphone 412 to indicate whether the smartphone 412 is moving or a corresponding scanner (e.g., if IMU data shows that smartphone 412 is motionless but appears to be rotating according to images of the scanner 404, it can be assumed that the scanner 404 is rotating and is an unfixed scanner).

The rationale behind the insight may be justified as follows. At timestamp t and t+1, examples include the following equations according to Equations 9 and 10, respectively:

$${R}_{World}^{Phone} ( t ) = {R}_{World}^{Cam} ( t ) \cdot {R}_{Cam}^{QR} ( t ) \cdot {R}_{QR}^{Phone} \qquad Equation 9$$

$${R}_{World}^{Phone} ( t + 1 ) = {R}_{World}^{Cam} ( t + 1 ) \cdot {R}_{Cam}^{QR} ( t + 1 ) \cdot {R}_{QR}^{Phone} \qquad Equation 10$$

Through camera pose estimation, we have the following equation that denotes the changes of camera orientations:

$${R}_{World}^{Cam} ( t + 1 ) = {R}_{World}^{Cam} ( t ) \cdot {R}_{Cam} ( t ) \qquad Equation 11$$

R_{cam}(t) denotes the rotation of the camera from timestamp t to timestamp t+1.

Suppose the rotation of the smartphone 412 from timestamp t to timestamp t+1 is denoted as R_{Phone}(t), examples have the following equation 12 to denote the relationship between the rotation matrix of the smartphone in the world frame at t and t+1:

$${R}_{World}^{Phone} ( t + 1 ) = {R}_{World}^{Phone} ( t ) \cdot {R}_{Phone} ( t ) \qquad Equation 12$$

As a result, examples have the following equation to get the rotation of the smartphone at timestamp t:

$${R}_{Phone} ( t ) = {{R}_{QR}^{Phone}}^{T} \cdot {{R}_{Cam}^{QR}}^{T} ( t ) \cdot {R}_{Cam} ( t ) \cdot {R}_{Cam}^{QR} ( t + 1 ) \cdot {R}_{QR}^{Phone} \qquad Equation 13$$

On the smartphone side, examples use IMU sensor data to determine the rotational motions of the smartphone 412. On the scanner 404 side, we estimate the smartphone poses based on smartphone 412 pose estimation techniques (described below) and camera pose techniques (described below) from the recorded video. Examples may further apply data pre-processing to reduce noise and outliers (described below). After receiving rotational motion data from both the scanner 404 and smartphone 412, the server calculates correlation (described below).

### Smartphone Pose Estimation

The rotation matrix

$${R}_{Cam}^{QR} ,$$

represents the orientation of the QR code 414 relative to the camera frame 406. To estimate

$${R}_{Cam}^{QR} ,$$

examples use a Perspective-n-Point (PnP) method, which minimizes the reprojection error between 3D-2D point correspondences. Specifically, examples define a matrix

$${T}_{Cam}^{QR} ,$$

to represent the homogeneous transformation from the camera coordinate system of the camera frame 406 to the QR code coordinate system of the QR code frame 408, as shown in Equation 14 below. The matrix includes a 3×3 rotation matrix

$${R}_{Cam}^{QR}$$

and a 3×1 positon vector

$${P}_{Cam}^{QR} . \qquad Equation 14$$

$${T}_{Cam}^{QR} = [ \begin{matrix}{R}_{Cam}^{QR} & {P}_{Cam}^{QR} \\ {0}_{1 \times 3} & 1\end{matrix} ]$$

Using the transformation matrix

$${T}_{Cam}^{QR} ,$$

the coordinates un punto within the image plane can be described by Equation 15 below, following the pinhole camera model:

$$[ \begin{matrix}{U}_{i} \\ {V}_{i} \\ 1\end{matrix} ] = [ \begin{matrix}{f}_{x} & 0 & {c}_{x} & 0 \\ 0 & {f}_{y} & {c}_{y} & 0 \\ 0 & 0 & 1 & 0\end{matrix} ] \cdot {T}_{\vert Cam}^{QR} \cdot [ \begin{matrix}{X}_{i} \\ {Y}_{i} \\ {Z}_{i} \\ 1\end{matrix} ] \qquad Equation 15$$

In Equation 15, [Xᵢ Yᵢ Zᵢ] represents the 3D position vector of the i-th known feature point on the screen of the smartphone 412, and [Uᵢ Vᵢ] denotes the 3D position vector's corresponding 2D position vector in the image frame of the camera. Since the feature points on the screen of the smartphone 412 are on the same plane, the Zᵢ coordinates in the QR code frame 408 are uniformly set to zero. In Equation 15, fₓ and f_{y} are the focal lengths in pixel units, while (cₓ, c_{y}) denotes the principal point, located at the center of the image. The
parameters fₓ, f_{y}, cₓ, and c_{y} are intrinsic to the camera and may be obtained through a one-time preliminary camera calibration. By identifying the feature points within the image plane and supplying their corresponding 3D coordinates, examples can determine the transformation matrix

$${T}_{Cam}^{QR}$$

using Equation 15. Examples estimate the rotation matrix of the smartphone 412 in each video frame, and obtain a sequence of the rotation matrix,

$${R}_{Cam}^{QR} ( T ) = \{ {R}_{Cam}^{QR} ( 1 ) , {R}_{Cam}^{QR} ( 2 ) , ... , {R}_{Cam}^{QR} ( t ) \} .$$

The rotation matrix sequence

$${R}_{Cam}^{QR} ( T )$$

is then applied to estimate the pose changes of the smartphone 412 in the coordinate system of the smartphone frame 410. The rotation matrix sequence

$${R}_{Cam}^{QR} ( T )$$

is then applied to estimate the pose changes of the smartphone 412 in the sensor coordinate system of the smartphone 412, as shown in Equation 13.

The on-screen layout design is discussed. While three points, (e.g., the corners

of the QR code 414), may be sufficient to solve a PnP problem, using additional points may enhances the accuracy and stability of pose estimation, particularly in noisy scenarios. Moreover, placing feature points near the edges and corners of the smartphone screen increases the detection period, enabling the estimation of a pose of the smartphone 412 even before or after the QR code 414 is detected. Therefore, the QR code 414 design may include an on-screen layout that facilitates the easy and accurate detection of multiple feature points. Compared to QR codes, AruCo markers are more specialized and provide precise tracking in computer vision systems. Accordingly, examples design an optimal screen layout that combines a payment QR code with various AruCo markers.

### Camera Pose Estimation

As hand-held scanners are free to move in the world frame 402, examples perform camera pose estimation to eliminate and/or reduce the effects of changes in camera poses of the scanner 404. Camera pose estimation may be the foundation of 3D reconstruction. Learning-based methods have explored predicting camera poses from a sparse set of input images, utilizing modeling, and denoising diffusion for inference. Among these, “RayDiffusion” achieves top performance by representing a camera as a collection of rays, reframing pose inference as a task of ray prediction, and using a denoising diffusion model to learn camera poses.

Although RayDiffusion achieves state-of-the-art performance in camera pose estimation, traditional RayDiffusion techniques are not directly applied to the visual code scenario described herein. First, current camera pose estimation methods including traditional RayDiffusion techniques infer camera poses based on the scene of static objects like cups, bags, and chairs. By contrast, the object captured by a scanner in a visual code scenario is mainly a smartphone, which is held and moved by users. If camera pose estimation is applied directly, traditional RayDiffusion cannot achieve satisfactory estimation results as it cannot distinguish whether the pose changes are due to the movement of the smartphone 412 or the camera itself. Second, traditional RayDiffusion predicts camera poses using a diffusion model, the inference stage of which requires repeated evaluations of the noisy input space, demanding large computationally cost. The visual code scheme features quickness, thus it is preferable to output the authentication decision in real time.

To address the first point, examples exclude the moving objects of the frame and use the static parts for camera pose estimation. Examples perform smartphone detection with “YOLOv8,” a fast and accurate object detection model. Examples exclude the area of the smartphone 412 and use the rest of the video frame for camera pose estimation. The rest area is the background of the scene, such as a checkout counter, wall, grocery shelves, etc. These objects are static and can be used for camera pose estimation.

To address the second challenge, examples decrease the amount of video frames of interest. Although the scanner 404 is free to move, the scanner 404 moves only slightly when the scanner 404 is scanning and decoding the QR code 414. Thus, examples employ two strategies to decrease the amount of video frames used for camera pose estimation. First, only frames where the QR code 414 is detectable are selected for camera pose estimation. Second, within these frames, examples perform down-sampling to further decrease the number of frames.

Through the camera pose estimation process, examples obtain a sequence of camera poses,

$${R}_{World}^{Cam} ( T ) = \{ {R}_{World}^{Cam} ( 1 ) , {R}_{World}^{Cam} ( 2 ) , ... , {R}_{World}^{Cam} ( t ) \} .$$

With the sequence of camera poses, examples obtain the camera's rotation sequence R_{Cam}(T)={R_{Cam}(1), R_{Cam}(2), . . . , R_{Cam}(t)} based on Equation 11, and R_{Cam}(T) is then applied to estimate the pose of the smartphone 412 changes in its sensor coordinate system with Equation 13.

### Data Pre-Processing

After getting the estimated smartphone poses relative to the camera and the estimated camera poses, examples estimate the rotational angle of the smartphone 412 based on Equation 13. Examples then transform the inferred rotational angle into rotational speed taking the time period between frames into account. Upon obtaining the smartphone 412 rotational speed inferred by the scanner 404, along with the user identification decoded form the QR code 414. The server retrieves the corresponding IMU data from the smartphone 412 for comparison. Since the motion data estimated by the scanner 404 and collected by the smartphone's IMU may both fluctuate and contain noise, examples apply pre-processing to the motion data. Examples may use linear interpolation to fill any gaps in the data that result from uneven sampling. Since motion data may contain high-frequency noise caused by environmental vibrations, such as sounds, examples apply a low-pass filter to eliminate this high-frequency noise. Given that vibrations from human movement typically occur below 10 Hz, examples can use a low-pass Butterworth filter with a 10 Hz cutoff frequency. Additionally, examples apply a median filter to remove outliers and smooth the data. In this way, two sequences of rotational speed data are obtained, denoted as

$${G}_{S} = \{ {G}_{S}^{( 1 )} , {G}_{S}^{( 2 )} , ... {G}_{S}^{( n )} \}$$

estimated by the scanner 404, and

$${G}_{P} = \{ {G}_{P}^{( 1 )} , {G}_{P}^{( 2 )} , ... {G}_{P}^{( n )} \}$$

collected by the IMU of the smartphone 412. Each data point in these rotational speed sequences contains three components, each measuring the rotational speed applied to the smartphone along one of the sensor coordinate system's axes. The rotational speed, as estimated by the camera and collected by the smartphone's gyroscope after pre-processing.

### Correlation Determination

After pre-processing, examples obtain sequences of rotational speed, G_{S} and G_{P}. Each data point in these sequences contains three components, representing the rotational motion projections along each sensor axis. To determine the correlation between the data sequences from the camera and smartphone 412, examples calculate the Euclidean distances for each attribute in the sequences separately. To accommodate variations in the length of data n each time a user presents a QR code 414, examples compute the average distances by dividing the Euclidean distances of each attribute by n. These averaged Euclidean distances are then used as features for training a classification model.

The IMU has proven to be a reliable tool for assessing various motion ranges, as noted in previous research studies. For short time intervals, the impact of IMU drift caused by integration errors, sensor bias, and sensor noise is minimal. However, the accuracy of sensors of the smartphone 412 may vary across different devices. To enhance our system's resilience and account for potential inaccuracies in IMU measurements, examples may utilize correlation to evaluate the shape similarity between data sequences. Such an approach leverages the observation that, despite potential inaccuracies and drift in IMU sensor data, the overall trend, whether increasing or decreasing, remains consistent. Specifically, examples use the PCC, a widely-used metric for quantifying the correlation between two time series. The PCC is computed as the covariance between two data sequences, divided by the product of their standard deviations. PCC values range from −1 to 1, with 1 indicating a perfect positive linear relationship, −1 indicating a perfect negative linear relationship, and 0 indicating no linear relationship.

In addition to using Euclidean distances and PCC scores, examples also incorporate the following features to further represent the similarity between data sequences: minimum, maximum, difference between minimum and maximum, average, standard deviation, median absolute deviation, and median. Examples further compute the Fisher score to select essential features.

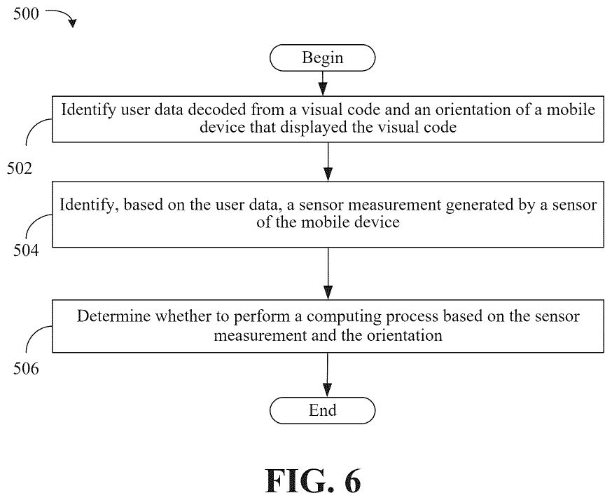

FIG. 6 shows a method 500 of authenticating a user based on visual codes and orientation of a mobile device. The method 500 may generally be implemented in any of the examples herein. In an embodiment, the method 500 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 500 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 502 identifies user data decoded from a visual code and an orientation of a mobile device that displayed the visual code. Illustrated processing block 504 identifies, based on the user data, a sensor measurement generated by a sensor of the mobile device. Illustrated processing block 506 determines whether to perform a computing process based on the sensor measurement and the orientation.

In some aspects, the method 500 performs the computing process in response to the orientation being within a distance of the sensor measurement. In some aspects, the method 500 fetch sensor data from an application deployed on the mobile device, and determines the sensor measurement based on the sensor data. In some aspects, the method 500 blocks the computing process from being performed if the sensor measurement does not match the orientation. In some aspects, the sensor measurement includes sensed orientation measurements of the mobile device, and the orientation includes detected positional measurements of the mobile device. In some aspects, the sensor measurement is representative of motion of the mobile device, and the detected orientation is dynamic orientation that is representative of motion of the mobile device. In some aspects, the sensor measurement is representative of sensed angular velocity and the detected dynamic orientation is representative of sensed angular velocity. In some aspects, the visual code is a quick-response code including a 2-dimensional matrix. In some aspects, the visual code includes a visual pattern on the mobile device.

In some aspects, a scanner is configured to capture the visual code. In some aspects, the scanner is configured to capture an image of the mobile device displaying the visual code, identify the visual code from the image, detect the orientation from the image, decode the visual code to generate the user data, and transmit the user data, and the orientation the physical characteristic to the device. In some aspects, the scanner is configured to transmit a request to execute the computing process to the device. In some aspects, the scanner is configured to estimate a pose of the mobile device based on a first marker, a second marker and a third marker of the visual code, and store the pose as the orientation. In some aspects, the scanner is configured to determine a rotation matrix that translates a world coordinate system to a mobile device coordinate system, where to estimate the pose, the scanner determines the pose based on gravity values along axes of the mobile device and the rotation matrix. In some aspects, the image includes a plurality of two-dimensional (2D) images, and the scanner is configured to estimate three-dimensional (3D) motions of the mobile device from the 2D images, and store the 3D motions as the orientation of the mobile device. In some aspects, the scanner includes an imaging sensor.

In some aspects, the techniques described herein further include a scanner configured to capture the visual code. In some aspects, the method 500 receives an image of the mobile device from a scanner; the image encodes the user data; and the orientation is determined based on the image.

Example sizes/models/values/ranges may have been given, although embodiments are not limited to the same. As manufacturing techniques (e.g., photolithography) mature over time, it is expected that devices of smaller size could be manufactured. In addition, well known components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computing device, comprising:
a processor; and
a memory coupled to the processor, the memory including a set of instructions, which when executed by the processor, cause the processor to perform operations including:
identifying user data decoded from a visual code and an orientation of a mobile device that displayed the visual code;
identifying, based on the user data, a sensor measurement generated by a sensor of the mobile device; and
determining whether to perform a computing process based on the sensor measurement and the orientation.

2. The computing device of claim 1, wherein the set of instructions, when executed, cause the processor device to perform operations further including:
performing the computing process in response to the orientation being within a distance of the sensor measurement.

3. The computing device of claim 1, wherein the set of instructions, when executed, cause the processor device to perform operations further including:
fetching sensor data from an application deployed on the mobile device; and
determining the sensor measurement based on the sensor data.

4. The computing device of claim 1, wherein the set of instructions, when executed, cause the processor device to perform operations further including:
blocking the computing process from being performed when the sensor measurement does not match the orientation.

5. The computing device of claim 1, wherein:
the sensor measurement includes sensed orientation measurements of the mobile device, and
the orientation includes detected positional measurements of the mobile device.

6. The computing device of claim 1, wherein:
the sensor measurement is representative of motion of the mobile device, and
the orientation is dynamic orientation that is representative of motion of the mobile device.

7. The computing device of claim 6, wherein:
the sensor measurement is representative of sensed angular velocity, and
the detected dynamic orientation is representative of sensed angular velocity.

8. The computing device of claim 1, wherein the visual code is a quick-response code comprising a 2-dimensional matrix.

9. The computing device of claim 1, wherein the visual code comprises a visual pattern on the mobile device.

10. A system, comprising:
the computing device of claim 1; and
a scanner, positioned remotely from the computing device, configured to capture the visual code.

11. The system of claim 10, wherein the scanner is further configured to:
capture an image of the mobile device displaying the visual code; and
identify the visual code from the image.

12. The system of claim 11, wherein the scanner is further configured to:
detect the orientation from the image;
decode the visual code to generate the user data; and
transmit the user data and the orientation to the computing device.

13. The system of claim 12, wherein the scanner is further configured to transmit a request to execute the computing process to the computing device.

14. The system of claim 10, wherein the scanner is further configured to:
estimate a pose of the mobile device based on a first marker, a second marker and a third marker of the visual code; and
store the pose as the orientation.

15. The system of claim 14, wherein the scanner is further configured to determine a rotation matrix that translates a world coordinate system to a mobile device coordinate system.

16. The system of claim 15, wherein to estimate the pose, the scanner determines the pose based on gravity values along axes of the mobile device and the rotation matrix.

17. The system of claim 11, wherein the image includes a plurality of two-dimensional (2D) images, and the scanner is configured to:
estimate three-dimensional (3D) motions of the mobile device from the 2D images; and
store the 3D motions as the orientation of the mobile device.

18. The system of claim 10, wherein the scanner comprises an imaging sensor.

19. The system of claim 10, wherein:
the computing device is configured to receive an image of the mobile device from a scanner;
the image encodes the user data; and
the orientation is determined based on the image.

20. A method, comprising:
identifying user data decoded from a visual code and an orientation of a mobile device that displayed the visual code;
identifying, based on the user data, a sensor measurement generated by a sensor of the mobile device; and
determining whether to perform a computing process based on the sensor measurement and the orientation.
